SEQUENCE LISTING (2 sequences)

SEQ ID NO: 1 - DNA, 526 bp, Bifidobacterium animalis
  misc_feature (494)..(494): n is a, c, g, or t
tggggcacggtagtgcccgatatgggatgcttcctttcctggccgtgtggccgggtggtgtcccttgctggctggaaaaaggtcaaggcgcctgcgcccttgtggtgtgggtggacagtggtgtggtgcatgctgttgggttcccggaccgccaggccccttgtcgggggtggtgttccgttcccgccgtcctggccgtgccccttgtggggtgggtgcctggggtggtgtggggtggtggtttgagaactggagagtggacgcgagcatgaacggtgtgccttttggggtgtgccgggtgtgttcgtactgttgattttgtcgaaccgttccgtgcccgcctttcgggtgggtgcgtggattgtgttcgcgagtgttttggtaagccccccgcactgttggtgtgggtggtgtttaaatgatctgattaattgtcgtaaggtgttccagtgcaagtggcatgggcccgtggccccctttttgcgggggttggngggttttttccatggncgtatggnggaatcct

SEQ ID NO: 2 - DNA, 18 bp, Artificial Sequence
  Chemically synthesized nucleotide sequence
gctggatcacctcctttc

(19) United States
(12) Patent Application Publication
(10) Pub. No.: US 2015/0173397 A1
(43) Pub. Date: Jun. 25, 2015

(54) PET FOOD COMPOSITION HAVING PROBIOTIC BIFIDOBACTERIUM ANIMALIS

(71) Applicant: THE LAMS COMPANY, CINCINNATI, OH (US)

(72) Inventors: Maria Dolores Martinez Villagran, Mason, OH (US); Rajesh Bund, Cincinnati, OH (US); Isoken Omosefe Igwekala-Nweke, Springdale, OH (US)

(73) Assignee: THE LAMS COMPANY, CINCINNATI, OH (US)

(21) Appl. No.: 14/136,528

(22) Filed: Dec. 20, 2013

(51) Int. Cl. A23K 1/00; A23K 1/16; A23K 1/18

(52) U.S. Cl. CPC A23K 1/008; A23K 1/1853; A23K 1/16; A23K 1/003; A23K 1/004; A23Y 2300/21

(57) ABSTRACT

A probiotic coated kibble having internal glycerin.

### FIELD OF THE INVENTION

The present invention relates to pet food compositions comprising probiotics.

### BACKGROUND OF THE INVENTION

Research has begun to highlight some valuable strains of bacteria and their potential use as probiotic agents. Probiotics are considered to be preparations of bacteria, either viable or dead, their constituents such as proteins or carbohydrates, or purified fractions of bacterial ferments that promote mammalian health by preserving and promoting the natural microflora in the GI tract, and reinforcing the normal controls on aberrant immune responses. It is believed by some that probiotic bacteria are more effective when derived from the species, or a closely related species to the individual intended to be treated. Therefore, there is a need for probiotic strains derived from companion animals to be used for companion animals that are different to those derived from humans.

One of the constant difficulties in effectively using probiotics has been in providing an effective dose. And this usually involves keeping enough of the bacteria alive until the time of ingestion. The number of bacteria once mixed with a product, for example yogurt, may decline between the time of manufacture and sale to such a point that when they are finally ingested their numbers are too small to provide a beneficial effect. Another issue involving probiotic effectiveness can involve the manufacturing of the product to which the bacteria are introduced. Most current manufacturing conditions are not favorable to the application of bacteria, for example extreme heat, cold or pressure, all of which can detrimentally reduce bacterial populations. Another factor is compatibility of the bacteria with the product to which it is applied. While bacteria may provide a beneficial effect, when coupled with the product there may be a component of the product which is harmful to the bacteria. Or the manner in which the components are added to the product may be harmful to the product, such that individual components of the product are only harmful to the bacteria if added in a certain manner or sequence.

All of the above is especially true when looking at the preparation of pet food products, all of which traditionally have been made and formulated in a manner to prevent the growth of bacteria. One example is the use of plasticizers such as glycerin, which is typically used in treats or simulated moist meat chunks in the Pet Food to enhance flavor and/or texture, and/or alter the water activity of the finished product. Therefore the introduction of bacteria into pet food products has been a constant challenge. Not only in trying to keep the beneficial bacteria alive, in the form of probiotics, but also prevent the growth of harmful bacteria. What is needed is a pet food that can deliver an effective amount of probiotic bacteria to provide a benefit.

### SUMMARY OF THE INVENTION

A coated kibble is provided which comprises a kibble; a coating on the kibble comprising a fat; a coating on the kibble comprising a probiotic; wherein the kibble comprises internal glycerin.

A method is provided for producing a coated kibble which comprises extruding a kibble having internal glycerin; and coating the kibble with Bifidobacterium animalis.

### BRIEF DESCRIPTION OF THE DRAWINGS

FIG. 1 is a schematic, cross-sectional view of an exemplary coated food product.

FIG. 2 is a graph demonstrating stability of AHC-7 probiotic at 23° C. in presence of glycerin and non-glycerin systems.

FIG. 3 is a graph demonstrating stability of AHC-7 probiotic at 40° C. in presence of glycerin and non-glycerin system.

FIG. 4 is a graph demonstrating the stability of AHC-7 probiotic in the presence and absence of externally coated glycerin.

FIG. 5 is a graph demonstrating the stability of AHC-7 bacteria in the presence and absence of internal glycerin.

FIG. 6 is a graph demonstrating AHC-7 stability on kibble in the presence and absence of internal glycerin at two different levels.

### DETAILED DESCRIPTION OF THE INVENTION

The present invention comprises a food product; for example, a kibble comprising glycerin and a probiotic, such as Bifidobacterium animalis (AHC-7) coated on the outside of the kibble. It was found that the stability of AHC-7 was compromised if glycerin was coated on the outside of the kibble along with AHC-7, such that the AHC-7 was in contact with the glycerin. However, if the glycerin was incorporated into the kibble and AHC-7 was applied to the kibble surface, the AHC-7 was stable.

As used herein, “companion animal” means a domestic animal, for example a domestic canine, feline, rabbit, ferret, horse, cow, or the like.

As used herein, the term “mutants thereof” includes derived bacterial strains having at least 93% homology, at least 96% homology, or at least 98% homology to the 16s-23s intergenic spacer polynulceotide sequence of a referenced strain, but otherwise comprising DNA mutations in other DNA sequences in the bacterial genome.

As used herein, the term “DNA mutations” includes natural or induced mutations comprising at least single base alterations including deletions, insertions, transversions, and other DNA modifications known to those skilled in the art, including genetic modification introduced into a parent nucleotide or amino acid sequence while maintaining at least 50% homology to the parent sequence. The sequence comprising the DNA mutation or mutations may have at least 60%, at least 75%, or at least 85% homology with the parental sequence. As used herein, sequence “homology” can be determined using standard techniques known to those skilled in the art. For example, homology may be determined using the on-line homology algorithm “BLAST” program, publicly available at http://www.ncbi.nlm nih.gov/BLAST/.

### Sequences

SEQ. ID NO. 1: 16s-23s intergenic spacer nucleotide sequence from Bifidobacterium animalis AHC-7 (NCIMB 41199).
SEQ. ID NO. 2: Primer sequences for 16s-23s DNA sequence analysis.

### Bacterial Deposit Numbers

The table below indicates Bifidobacterium animalis strains that can be used in the present invention. The bacterial strains are deposited with the National Collections of Industrial Food and Marine Bacteria (NCIMB), Aberdeen, UK.

| Strain | Deposit Number | 16s-23s Sequence |
|---|---|---|
| Bifidobacterium animalis AHC-7 | NCIMB 41199 | SEQ. ID NO. 1 |

Probiotics are micro-organisms, either viable or dead, processed compositions of micro-organisms, their constituents such as proteins or carbohydrates, or purified fractions of bacterial ferments that beneficially affect a host. The general use of probiotic bacteria is in the form of viable cells. However, it can be extended to non-viable cells such as killed cultures or compositions containing beneficial factors expressed by the probiotic bacteria. This may include thermally killed micro-organisms, or micro-organisms killed by exposure to altered pH or subjected to pressure. For the purpose of the present invention, “probiotics” is further intended to include the metabolites generated by the micro-organisms used in the present invention during fermentation, if they are not separately indicated. These metabolites may be released to the medium of fermentation, or they may be stored within the micro-organism. As used herein “probiotic” also includes bacteria, bacterial homogenates, bacterial proteins, bacterial extracts, bacterial ferment supernatants, and mixtures thereof, which perform beneficial functions to the host animal when given at a therapeutic dose.

It has been found that strains of Bifidobacterium animalis obtainable by isolation directly from resected and washed GI tract of mammals are adherent to the GI tract, following feeding of viable bacterial cells, and are also significantly immunomodulatory when fed to animals in viable, non-viable or fractionated form. Without being bound by theory, it is believed that the Bifidobacterium animalis obtainable by isolation from resected and washed GI tract, closely associates with the gut mucosal tissues. Without further being bound by theory, this is believed to result in the probiotic Bifidobacterium animalis of the present invention generating alternative host responses that result in its probiotic action. It has been found that probiotic bacteria obtainable by isolation from resected and washed GI tract can modulate the host's immune system, via direct interaction with the mucosal epithelium and the host's immune cells. This immunomodulation, in conjunction with the traditional mechanism of action associated with probiotic bacteria, i.e. the prevention of pathogen adherence to the gut by occlusion and competition for nutrients, results in the Bifidobacterium animalis of the present invention being highly efficacious as a probiotic organism.

The Bifidobacterium animalis of the present invention, obtainable by isolation from resected and washed canine GI tract, have in vitro anti-microbial activity against a number of pathogenic bacterial strains/species, as measured by zones of inhibition or bacterial growth inhibition assays known to those skilled in the art. Without being bound by theory, it is believed that this in vitro anti-microbial activity is indicative of potential probiotic activity in vivo in animals, such as canines and felines. The bacteria of the present invention may have in vitro anti-microbial activity against Salmonella typhimurium, Listeria monocytogenes, Listeria innocua or Eschericia coli, or combinations thereof.

Without being bound by theory, it is believed that the anti-microbial activity of the Bifidobacterium animalis bacteria of the present invention may be the result of a number of different actions by the Bifidobacterium animalis bacteria herein. It has previously been suggested in the art that several strains of bacteria isolated from fecal samples exert their probiotic effect in the GI tract following oral consumption, by preventing the attachment of pathogenic organisms to the gut mucosa by occlusion. This requires oral consumption of “live” or viable bacterial cells in order for a colony of bacteria to be established in the gut. However, it is believed that the Bifidobacterium animalis used in the present invention, while exerting some probiotic effect due to occlusion if given in a viable form, may deliver a substantial probiotic effect in either the viable or non-viable form due to the production during fermentation in vitro of a substance or substances that either inhibit the growth of or kill pathogenic micro-organisms, and/or alter the host animal's immune competence. This form of probiotic activity is desirable, as the bacteria of the present invention can be given as either viable or non-viable cultures or purified fermentation products and still deliver a beneficial therapeutic effect to the host animal.

In certain embodiments, the Bifidobacterium animalis bacteria of the present invention are able to maintain viability following transit through the GI tract. This is desirable in order for live cultures of the bacteria to be taken orally, and for colonization to occur in the intestines and bowel following transit through the esophagus and stomach. Colonization of the intestine and bowel by the bacteria of the present invention is desirable for long-term probiotic benefits to be delivered to the host. Oral dosing of non-viable cells or purified isolates thereof induces temporary benefits, but as the bacteria are not viable, they are not able to grow, and continuously deliver a probiotic effect in situ. As a result this may require the host to be dosed regularly in order to maintain the health benefits. In contrast, viable cells that are able to survive gastric transit in the viable form, and subsequently colonize by adhering to and proliferating on the gut mucosa are able to deliver probiotic effects continuously in situ.

Therefore, in certain embodiments the bacteria of the present invention maintain viability after suspension in a media having a pH of 2.5 for 1 hour. As used herein, “maintain viability” means that at least 25% of the bacteria initially suspended in the test media are viable using the plate count method known to those skilled in the art. In certain embodiments, “maintain viability” means that at least 50% of the bacteria initially suspended are viable. It is desirable for the bacteria of the present invention to maintain viability following exposure to low pH as this mimics the exposure to gastric juices in the stomach and upper intestine in vivo following oral consumption in animals.

Furthermore, in certain embodiments the bacteria of the present invention have a growth of at least 33% when in the presence of at least 0.5% porcine bile salts. In further embodiments, the bacteria of the present invention have a growth of at least 33% when in the presence of at least 1% porcine bile salts. Without being bound by theory it is believed that the bacteria of the present invention, capable of growth in the presence of at least 0.5% porcine bile salts, are able to survive the conditions present in the intestine. This is thought to be a result of the addition of porcine bile to the culture medium mimicking the conditions of the intestine.

Further still, the Bifidobacterium animalis bacteria used in the present invention may have significant adhesion to gut epithelial cells in vitro. As used herein, “significant adhesion” means at least 4% of the total number of bacteria co-incubated with the epithelial cells in vitro adhere to the epithelial cells; or in certain embodiments, at least 6% of bacterial cells co-incubated adhere to epithelial cells in vitro. Without being bound by theory, it is believed that gut epithelial cell adherence in vitro is indicative of the bacteria's ability to colonize the GI tract of an animal in vivo.

The 16s-23s intergenic polynucelotide sequence is known to those skilled in the art as the sequence of DNA in the bacterial genome that can be used in order to identify different species and strains of bacteria.

In certain embodiments, the strain of Bifidobacterium animalis has a 16s-23s intergenic polynucleotide sequence that has at least 93%, at least 96%, or at least 99% homology with the polynucleotide sequence according to SEQ. ID NO. 1. In certain embodiments, the strain of bacteria according to the present invention has a 16s-23s polynucelotide sequence according to SEQ. ID NO. 1. In still further embodiments, the strain of bacteria according to the present invention is Bifidobacterium animalis strain NCIMB 41199 (AHC-7), or a mutant thereof.

The strain of bacteria of the genus Bifidobacterium animalis obtainable by isolation from resected and washed canine gastrointestinal tract can be used to deliver probiotic benefit following oral consumption in animals, such as companion animals or humans. This probiotic benefit generally maintains and improves the overall health of the animal. Non-limiting elements of animal health and physiology that benefit, either in therapeutically relieving the symptoms of, or disease prevention by prophylaxis include inflammatory disorders, immunodeficiency, inflammatory bowel disease, irritable bowel syndrome, cancer (particularly those of the gastrointestinal and immune systems), diarrheal disease, antibiotic associated diarrhea, appendicitis, autoimmune disorders, multiple sclerosis, Alzheimer's disease, amyloidosis, rheumatoid arthritis, arthritis, joint mobility, diabetes mellitus, insulin resistance, bacterial infections, viral infections, fungal infections, periodontal disease, urogenital disease, surgical associated trauma, surgical-induced metastatic disease, sepsis, weight loss, weight gain, excessive adipose tissue accumulation, anorexia, fever control, cachexia, wound healing, ulcers, gut barrier infection, allergy, asthma, respiratory disorders, circulatory disorders, coronary heart disease, anemia, disorders of the blood coagulation system, renal disease, disorders of the central nervous system, hepatic disease, ischemia, nutritional disorders, osteoporosis, endocrine disorders, and epidermal disorders. Preferred are treatment of the gastrointestinal tract, including treatment or prevention of diarrhea, immune system regulation, preferably the treatment or prevention of autoimmune disease and inflammation; maintaining or improving the health of the skin and/or coat system, preferably treating or preventing atopic disease of the skin; ameliorating or reducing the effects of aging, including mental awareness and activity levels; and preventing weight loss during and following infection.

The treatment of the disorders disclosed above may be measured using techniques known to those skilled in the art. For example, inflammatory disorders including autoimmune disease and inflammation may be detected and monitored using in vivo immune function tests such as lymphocyte blastogenesis, natural killer cell activity, antibody response to vaccines, delayed-type hypersensitivity, and mixtures thereof. Such methods are briefly described herein, but well known to those skilled in the art.

The method of use of the Bifidobacterium animalis bacteria of the present invention typically involves oral consumption by the animal. Oral consumption may take place as part of the normal dietary intake, or as a supplement thereto. The oral consumption typically occurs at least once a month, if not at least once a week, or at least once per day. The Bifidobacterium animalis bacteria used in the present invention may be given to the companion animal in a therapeutically effective amount to maintain or improve the health of the animal. As used herein, the term “therapeutically effective amount” with reference to the bacteria, means that amount of the bacteria sufficient to provide the desired effect or benefit to a host animal in need of treatment, yet low enough to avoid adverse effects such as toxicity, irritation, or allergic response, commensurate with a reasonable benefit/risk ratio when used in the manner of the present invention. The specific “therapeutically effective amount” will vary with such factors as the particular condition being treated, the physical condition of the user, the duration of the treatment, the nature of concurrent therapy (if any), the specific dosage form to be used, the carrier employed, the solubility of the dose form, and the particular dosing regimen.

The bacteria may be given to the companion animal at a dose of from about 10⁴ to about 10¹⁴ CFU per day or from about 10⁶ to about 10¹² CFU per day. A kibble in certain embodiments may contain at least 0.001% of from about 10⁴ to about 10¹² CFU/g of the Bifidobacterium animalis. The Bifidobacterium animalis bacteria can be given to the animal in either viable form, or as killed cells, or distillates, isolates or other fractions of the fermentation products of the bacteria of the present invention, or any mixture thereof.

The Bifidobacterium animalis bacteria, or a purified or isolated fraction thereof, are used to prepare a composition intended to maintain or improve the health of an animal. As indicated above, the composition may be part of the normal dietary intake, or a supplement. Where the composition comprises part of the normal dietary intake, the composition may be in the form of a pet food such as biscuits or kibbles.

FIG. 1 is a cross-sectional view of an exemplary coated kibble 18, a kibble 10 coated with one or more distinct coatings 12, 14, and 16. Any one or all coatings may cover the surface of the kibble completely or partially as shown by continuous or dotted lines in the figure. The selection and combination of coating 12, 14, and 16 may be useful in improving the taste, texture, or appearance of a coated kibble 18, which is the combined kibble 10 with one or more of coatings 12, 14, and 16. For the avoidance of doubt, any one or any combination of coatings 12, 14, and 16 may be present in different embodiments of the invention. At least one of the coatings 12, 14 and 16 will contain AHC-7. In certain embodiments AHC-7 can be applied on kibble either through dry or liquid medium consisting of flavor system in combination with other dry or liquid ingredients at different ratios. As shown in FIG. 1, in some embodiments the coatings 12, 14, and 16 may be distinct. That is, there may be insignificant mixing of the coatings after they are applied, with distinct layers of different coatings present. By insignificant mixing, it is recognized that there will be some interaction at the interface between different coatings, but there is not commingling of the coatings, such that, over time, there appears to be only one coating rather than two or more distinct coatings. Additional coatings, that is, more than three coatings, may be used. In FIG. 1, kibble 10 has a round shape; however, it should be understood that the food is not limited in shape and may have any shape or dimension desired for the product, taking into account both functional aspects of the volume and surface area of the food pieces and aesthetic considerations. Kibble 10 may be one component of a food product that comprises kibble of two or more different shapes, sizes, and/or compositions.

Kibble 10 may be a dried food, having a moisture content of less than about 20%, less than about 15%, less than about 12%, less than about 9%, or less than about 5%, water by weight of the kibble. Low moisture content may contribute to the shelf-stability of kibble 10, in particular, the resistance of kibble 10 to microbial growth over time. Kibble 10 comprises a plasticizer, such as glycerin. Glycerin has a low water activity (Aw), less than or equal to about 0.1. The glycerin can be added either internally in a kibble (internal glycerin) or externally as an enrobing agent (external glycerin). Externally added glycerin levels as low as 1% have a detrimental effect on the bacteria. Glycerin levels added internally to a kibble have shown little or no detrimental effect on the bacteria. When glycerin is added internally to a kibble, the glycerin is either injected into an extruder via the pre-conditioner cylinder or mixed with the ration. For external application of glycerin, the glycerin is coated on the kibble surface by any spraying and/or mixing method. The temperature of the glycerin is maintained, such that it is fluid enough for pumping and spraying. Kibble 10 internally comprises glycerin in certain embodiments at an amount from about 0.5% to about 35%, about 1% to about 20%, or about 5% to about 15%, by weight of the kibble, including any coatings. The inclusion of glycerin within kibble 10 at a certain level may make the kibble softer and easier to chew than a kibble of comparable moisture content with no glycerin. For example, kibble with glycerin inside the kibble may have a greater softness (lower measured compressive force) than a kibble with no internal glycerin by a factor of 2 or even 3, depending on the final moisture content, which in certain embodiments can be from about 0.1 aw to about 0.5 aw.

In addition to its function as a plasticizer glycerin may provide a sweet taste to the kibble. For kibbles intended to provide a savory taste, this sweet taste may be undesirable if the ratio is not balanced properly. The inclusion of an acid, such as formic acid, acetic acid, propionic acid, butyric acid, lactic acid, sorbic acid, fumaric acid, malic acid, tartaric acid, citric acid, phosphoric acid, ascorbic acid, sulfuric acid, hydrochloric acid, or combinations thereof, may reduce an alteration in taste associated with a plasticizer. The acid may be present at an amount greater than 0% and less than about 2%, or less than about 1.5% of the kibble. In some embodiments, the acid is incorporated into the glycerin, and the glycerin is added to the kibble as described above, that is, added into the kibble. In some embodiments, the acid is added to the kibble (internally or externally) separately from glycerin. In some embodiments, glycerin is used without adding offsetting amounts of acid or other sour-tasting ingredients (e.g., the food is presented with a sweet taste, rather than a savory taste). Some dogs, for example, may prefer a sweet taste, or glycerin may be used with a food intended to have a sweet taste.

A kibble can be any suitable composition that is ingestible by a human or an animal and that provides nutritional value to the human or animal. The kibble can be coated or uncoated prior to being treated as disclosed here. A kibble generally will be a basal food composition having a nutritionally balanced mixture of proteinaceous and farinaceous ingredients. The kibble can be baked, extruded, pelleted, or formed. Such forms of kibble, and methods for their production, are well known to those of skill in the art of food manufacturing. Extrusion and extrusion cooking, for example, are described on pages 794-800 of the Encyclopedia of Food Science and Technology, Volume 2 (Y. H. Hui, ed., John Wiley & Sons, Inc. 1992).

A kibble is not limited to a particular composition. A kibble may be a nutritionally complete and balanced animal diet which provides all essential nutrients to sustain life (with the exception of water). Nutritionally complete and balanced kibbles may meet consensus nutrient profiles, such as AAFCO standards for dog or cat food. A kibble may be a treat or supplement that is not nutritionally balanced, but may provide some nutritive value (e.g., calories). In such instances, the kibble may be used as a treat or supplement rather than a primary diet, or the kibble may be mixed with different particles so that the mix of kibble and other foodstuff is nutritionally complete and balanced. For example, the kibble may be mixed with nutritionally different kibble, or with fruit or vegetable pieces (such as carrot pieces, pea pieces, soy morsels, dried fruits, etc.), or with meat pieces (such as dried or preserved meats, including jerky, or otherwise prepared or preserved meats), or with tablets, capsules, or pellets comprising desired nutrients, or combinations thereof, such that the mixture is nutritionally complete and balanced. A kibble can be any suitable form, such as bite-size or pellet form of any shape.

Coating 12 is applied externally to the formed kibble. Coating 12 is a surface coating on or near the outside of kibble 10, recognizing that some of coating 12 may migrate into kibble 10 at the interface between kibble 10 and coating 12. In certain embodiments the coating 12 may comprise fat; and may provide assistance in ensuring adherence of dry matrix, which could be a flavor system with or without probiotic. The term “fat” refers to any edible grade fat or lipid, including fats of avian, animal, plant, or manufactured origin, including, but not limited to, crude or refined fats. Typical animal origin fats include, for example, animal tallow, choice white grease, lard, milk-derived fats such as butter oil, and fat typically contained in cheese. Typical fats of vegetable origin include coconut oil, soybean oil, and corn oil. Typical fats of avian origin include fats derived from the tissue of chickens, turkeys, ducks, and geese, for example.

Applying fat coating over a kibble containing glycerin may reduce the absorption of fat coating into kibble. Keeping fat coating on the surface of kibble may help enhance the flavor and/or mouth feel of the food at relatively lower levels of add-on fats, because a greater proportion of the fat is available at the interface between the food and the mouth when the food is consumed. Exemplary fats include poultry fat, such as chicken fat, and beef tallow. Fat coating may be present in an amount from about 1% to about 15%, about 6% to about 8%, or about 11% to 13%, by weight of the coated kibble. A hydrophobic fat coating may help retain moisture within the food; that is, to keep the food from losing additional moisture during transportation and storage, especially in dry conditions (relative humidity of less than about 35%). A heavier fat coating may be beneficial on foods comprising glycerin in the kibble, as compared to foods which do not comprise a plasticizer in the kibble. For example, coated kibble with a plasticizer in the kibble may have a fat coating which is about 11% to about 13% of the weight of the coated kibble. If the food product is a complete and nutritionally balanced pet food, it may be desirable to keep the total fat content of the food, including any fat in the kibble and the fat in all coating layers, to less than about 25% or less than about 20%, of the weight of the coated kibble, to ensure that other nutrients are present in suitable proportions.

Fat coating may comprise one or more structurants. The structurant may alter the concentration and/or crystalline order of the solids in fat coating. The structurant may alter other physiochemical properties, such as viscosity or density, of the fat coating. In particular, the structurant may prevent or reduce smearing of fat coating as coated kibble is processed, shipped, and used. For example, particles of coated kibble may interact with each other, manufacturing equipment (including packaging equipment), packaging, serving utensils, serving dishes, hands, and the like, and a structurant may help keep fat coating firm and resilient, so that the coating is not displaced or transferred away from the food during these interactions. A high melting point (greater than or equal to 60° C.) fat or edible wax may serve this purpose. A fat may be preferable to an edible wax for mouth feel or taste. Fat coating may comprise between about 1% to about 10%, or between about 2% to about 4%, of the structurant by weight of the fat coating composition. The structurant may comprise a gum, such as xanthan gum or guar gum, modifications thereof, or combinations thereof.

The structurant may comprise an emulsifier. The emulsifier may provide a polar component that improves the interaction between fat coating and other, hydrophilic coatings, if hydrophilic coatings are used. In some embodiments, the emulsifier may contribute to the transfer of fat from the food to the mouth, and the distribution of fat within the mouth, via interactions with aqueous saliva. Thus, the emulsifier may both help retain fat coating on the kibble surface, like a glaze, and improve the taste and/or mouth feel of the food when it is eaten. As such, an emulsifier may be desirable even if fat coating (e.g., before the addition of an emulsifier) is not an emulsion. The emulsifier may be present in an amount between about 1% to about 10% or between about 2% to about 5%, by weight of the fat coating composition. In some embodiments, an emulsifier is applied over the fat coating. When applied as a separate coating or separate coating layer, the emulsifier may be present in an amount between about 0.1% to about 5% or between about 1% to about 3%, by weight of the fat coating composition.

Any edible emulsifier may be used, for example, lecithins, polyglycerol esters, or combinations thereof. Some compounds, such as high melting temperature (60° C. to 80° C.) mono- and/or diglycerides may provide structural benefits and provide a polar component to fat coating. Such structurants may also increase the total melting point of the fat system (fat+structurant), depending on the level of the structurant in the fat system. Suitable mixes of glycerides are commercially available under the tradename Trancendim®, from Caravan Ingredients of Lenexa, Kans., USA. A suitable mix of glycerides, for example, is Trancendim (Registered trademark) 180 or Trancendim® 130. The structurant may be present at between about 0.1% to about 10% by weight of the fat coating composition. The structurant may be blended into the fat coating, such that there is a single coating of a composition comprising a fat and a structurant. In some embodiments, the structurant may be applied separately as an overlay coating on the fat coating.

A coating containing the probiotic 14 may be applied over the coating 12, which may be a fat coating. The AHC-7 coating describes the addition of AHC-7 to a kibble. In certain embodiments AHC-7 is applied by weight to a minimum level of about 10³ cfu/g, or from about 10⁶ cfu/g to about 10⁸ cfu/g or from about 10⁸ cfu/g to about 10¹⁰ cfu/g. AHC7 may also be applied to kibble matrix through other carriers like fatty acids, protein, monoglycerides, polysaccharides (carbohydrates, sugars, hydrocolloids etc.).

An additional coating or coatings 16 may be applied. Coating 16 may comprise dry or liquid additives. If fat coating 12 comprises an emulsifier, the emulsifier may enable the layering of liquid additives. The liquid additives may remain associated with fat coating 12 because of the emulsifier, but remain at the surface of fat coating 12 because of the incompatibility of the liquid additive (mostly hydrophilic) and the fat (mostly hydrophobic). This may be particularly, but not exclusively, helpful with liquid palatants, since it is most efficient to apply palatants on the outermost coating of the food so they are readily available to taste receptors in the mouth when the food is eaten. Since a liquid additive applied over fat coating 12 will be attracted to the surface but disinclined to pass through or mix with fat coating 12, the liquid additive should be more available at the surface of the food. Dry additives, including dry palatants or other dry ingredients, may be applied over fat coating 12 or over a liquid additive applied over fat coating 12. Generally, dry additives will acceptably adhere to either a fat-moistened or liquid-moistened surface. Some specific dry additives will have chemical properties which make it most advantageous to apply them directly to fat coating 12 or after a layer of liquid additives is applied over fat coating 12, or even to apply the dry additives as part of fat coating 12 or in the form of a liquid additive (as by dissolving or mixing the dry additive in water before applying it to the food). The ratio, by weight, of fat to a liquid additive may, in some embodiments, be between about 0.3 to about 8. Other ratios are feasible.

Coating 16 may comprise emulsifiers to lower the surface energy of the coated kibble, and reduce or prevent the kibbles from sticking together, such that the kibbles can be freely dispensed and easily eaten as distinct pieces. Of course, it may sometimes be desirable for the kibble to clump, as if forming a snack bar or treat from the coated kibble. Generally, if multiple coatings are applied over fat coating 12, it is desirable to place palatants on the outermost coating so they are most accessible to taste receptors in the mouth. Alternately, the palatants may be included in an inner layer at higher concentrations.

Adding the fat coating may seal in moisture and help maintain softness over time. In some embodiments, the softness of the food is increased by at least 20%, or by at least 40%, by using the method. In some embodiments, the softness of the food declines by no more than 25% when stored for 6 months at 18° C. to 22° C. and 40% to-60% relative humidity. Softness can be measured using the food softness test method described below. Softness may be helpful in that the process of masticating softer food may stimulate salivation more than masticating crunchy food, which may help transfer fat and palatants from the food to taste receptors in the mouth, and, therefore, improve the palatability of the food.

The food softness test is a compressive strain test. Using a calibrated Instron compression tester (or equivalent) with a 1KN load cell and plate/anvil set-up, place a piece of kibble as flat as possible at the point of testing (this will vary depending on the kibble shape being tested). The anvil is a cylindrical, flat-bottomed test fixture and must be larger in diameter than the kibble being tested. Set up the tester to compress the kibble to 33.33% of its original height. Repeat for at least 25 kibble pieces for each type of kibble tested. Sweep away any debris or residue between samples. Report the maximum load (kgf) pressure (maximum observed load/kibble surface area) and Young's Modulus (using the automatic calculation in Instron's Bluehill software or equivalent method). The mean maximum pressure and mean Young's Modulus are reported for each set of 25 samples. If using an Instron compression tester, the following parameters are used:
Test Parameters
   Test rate=6.35 mm/min
   Control mode=compressive extension
   End of test value 1=33% compressive strain

Compression testing results are reported as maximum load (kgf), which may be described differently for hard and soft kibbles. For hard kibbles, the results may be referred to as Hardness, and for soft kibbles, the results may be referred to as Chewiness or Softness. The Young's Modulus is used to describe the same characteristics of both soft and hard kibble.

Coatings as disclosed may be used to alter the texture (mouth feel and moistness perception) of a kibble. The texture can be measured by measuring the force required to crush the kibble. The force required to crush the kibble simulates chewing. In the case of kibbles that contain no glycerin added internally in the kibble, and covered with only fat containing an emulsifier, the kibbles may be lubricious with a crispy texture, and may have a softness value from about 4 to about 12 kgf, from about 3 to about 9 kgf, or from about 3.5 to about 5.5 kgf. Kibble with a soft texture may contain glycerin in certain embodiments internally, as discussed previously at an amount from about 0.5% to about 35%, about 1% to about 20%, or about 5% to about 15%, by weight of the kibble, and the texture can be measured as softness or chewiness, as described in the food softness test. Soft kibbles may have a “softness” value from about 1 kgf/cm² to about 9 kgf/cm², from about 3 kgf/cm² to about 8 kgf/cm², or from about 3 kgf/cm² to about 7 kgf/cm². The texture of the hard kibble can also be characterized with the Young's modulus of the kibble (force per area of kibble, kgf/cm²). For hard kibbles, the maximum pressure may be from about 12 to about 35 kgf/cm², or from about 12 to about 20 kgf/cm². Soft kibbles may show a Young's Modulus of about 1 to about 15 kgf/cm², or about 2 to about 7 kf/cm², or about 2.5 to about 5 kgf/cm². Kibbles with different textures and/or coatings can be blended in any desired ratio to provide texture variety for the pet.

One possible advantage of a coating or series of coatings as disclosed is to increase the amount of fat that stays on the surface of the kibble. The level of fat on the surface may be above about 25% of the total level of fat deposited as coating. For example, if about 10% of fat was added on top of the surface of the kibble, the desired level of surface fat may be at least about 2.5%, or even about 5% or more, with the remainder of the fat soaking into the kibble or other coating layers or both.

Generally, aside from nutritional balancing additives included in these products, such as vitamins and minerals, or other additives, such as preservatives and emulsifiers and the like, a kibble for the most part will consist of ingredients which may be described as substantially proteinaceous or substantially farinaceous. Although the following should not be considered limiting, a proteinaceous ingredient can generally be defined as any material having a protein content of at least about 15% by weight; whereas, a farinaceous material has a protein content substantially below this and has a major fraction of starchy or carbohydrate containing materials.

Examples of proteinaceous materials which are typically used in commercial pet foods include vegetable protein meals, such as soybean, cottenseed, or peanut meals, animal proteins such as casein, albumin, whey, including dried whey, and meat tissue including fresh meat as well as rendered or dried “meals” such as fish meal, poultry meal, meat meal, meat and bone meal, enzymatically-treated protein hydrolysates, and the like. Other types of proteinaceous materials include microbial protein such as yeast, and other types of protein, including materials such as wheat gluten or corn gluten. Yeasts may also add flavor; wheat or corn gluten may also act as texturizing agents and can be used to increase product porosity.

Examples of typical farinaceous materials include enzymatic farinaceous materials, grains such as corn, maize, wheat, sorghum, barley, and various other grains which are relatively low in protein. Numerous other materials could be added to a kibble which do not necessarily fall into either category (proteinaceous or farinaceous), including carbohydrates and legumes, such as alfalfa or soy.

Typical formulae for kibbles are well known in the art. In addition to proteinaceous and farinaceous materials, the compositions of the invention generally may include vitamins, minerals, and other additives such as flavorings, preservatives, emulsifiers and humectants. The nutritional balance, including the relative proportions of vitamins, minerals, protein, fat and carbohydrate, is determined according to dietary standards known in the veterinary and nutritional art.

Dry additives refer to any additives that comprise less than 40% of a polar solvent (such as water) by weight of the dry additive at the time it is applied to a food. Exemplary additives that may be provided in dry form include various flavors, such as meat and cheese flavorings; meat solids and dry animal digest; herbs; dry palatants; hydrolyzed (by chemical or enzyme) vegetable proteins; minerals; prebiotics; probiotics; encapsulated compounds; nutrients; pharmaceutical or homeopathic compounds; colorants; and combinations thereof. Other examples of dry additives include Bakery yeast or Brewer's yeast, which comprise dried pulverized cells of a yeast of the genus Saccharomyces (usually S. cerevisiae), often used in brewing, Torula yeast, and various yeast extracts. A variety of yeasts and yeast extracts are known to be useful as palatants, prebiotics, or probiotics, and other edible microbes, living or dead, or microbial extracts may be desirable for the same or other purposes.

Liquid additives refer to any additives that comprise at least 40%, at least 50%, at least 60%, or up to 90% of a polar solvent (such as water) by weight of the liquid additive composition. Liquid additives include dry additives which have been dissolved, suspended, or submersed in a polar solvent prior to application to a food. Exemplary palatants that may be provided in liquid form include digests of animal origin; vitamins; amino acids; proteins or protein hydrolysates, including proteins or protein hydrolysates of vegetable origin, proteins or protein hydrolysates of animal origin, and synthetic proteins; other nutrients; yeast suspensions; flavor compositions; acidulents; dye compositions; broths; antioxidants; and combinations thereof.

The kibbles comprising the bacteria of the present invention may also comprise a prebiotic. “Prebiotic” includes substances or compounds that are fermented by the intestinal flora of the pet and hence promote the growth or development of bacteria in the gastro-intestinal tract of the pet at the expense of pathogenic bacteria. The result of this fermentation is a release of fatty acids, in particular short-chain fatty acids in the colon. This has the effect of reducing the pH value in the colon. Non-limiting examples of suitable prebiotics include oligosaccharides, such as inulin and its hydrolysis products commonly known as fructooligosaccharides, galacto-oligosaccarides, xylo-oligosaccharides or oligo derivatives of starch. The prebiotics may be provided in any suitable form. For example, the prebiotic may be provided in the form of plant material which contains the fiber. Suitable plant materials include asparagus, artichokes, onions, wheat or chicory, or residues of these plant materials. Alternatively, the prebiotic fiber may be provided as an inulin extract, for example extracts from chicory are suitable. Suitable inulin extracts may be obtained from Orafti SA of Tirlemont 3300, Belgium under the trade mark “Raftiline.” For example, the inulin may be provided in the form of Raftiline (g) ST which is a fine white powder containing about 90% to about 94% by weight of inulin, up to about 4% by weight of glucose and fructose, and about 4% to about 9% by weight of sucrose. Alternatively, the fiber may be in the form of a fructooligosaccharide such as obtained from Orafti SA of Tirlemont 3300, Belgium under the trade mark “Raftilose.” For example, the inulin may be provided in the form of Raftilose (g) P95. Otherwise, the fructooligosaccharides may be obtained by hydrolyzing inulin, by enzymatic methods, or by using micro-organisms.

For dried kibbles, a suitable process is extrusion cooking, although baking and other suitable processes may be used. If a prebiotic is used, the prebiotic may be mixed with the other ingredients of the dried kibble prior to processing.

Kibbles may contain other active agents such as long chain fatty acids and zinc. Suitable long chain fatty acids include alpha-linoleic acid, gamma linolenic acid, linoleic acid, eicosapentanoic acid, and docosahexanoic acid. Fish oils are a suitable source of eicosapentanoic acids and docosahexanoic acid.

Borage oil, blackcurrent seed oil, and evening primrose oil are suitable sources of gamma linolenic acid. Safflower oils, sunflower oils, corn oils, and soy bean oils are suitable sources of linoleic acid. These oils may also be used in the coating substrates referred to above Zinc may be provided in various suitable forms, for example as zinc sulfate or zinc oxide. Further, many ingredients commonly used in pet foods are sources of fatty acids and zinc. It has been observed that the combination of chicory, as a source of prebiotic, with a linoleic-acid rich oil, such as soy bean oil, provides unexpected benefits, suggestive of a synergistic effect.

### EXAMPLES

### Example 1

As a coating AHC-7 probiotic is expected to be in direct contact with kibble raw material and other coatings, such as flavoring agents, fat, palatant, and any other ingredient applied externally for improvement of texture like glycerin or emulsifiers. In order to understand the impact on AHC-7 caused by interaction with other materials several samples were prepared at appropriate ratios; the samples comprised AHC-7 probiotic and one coating component, which comprised either chicken fat, dry palatant (SPF 336) or glycerin.

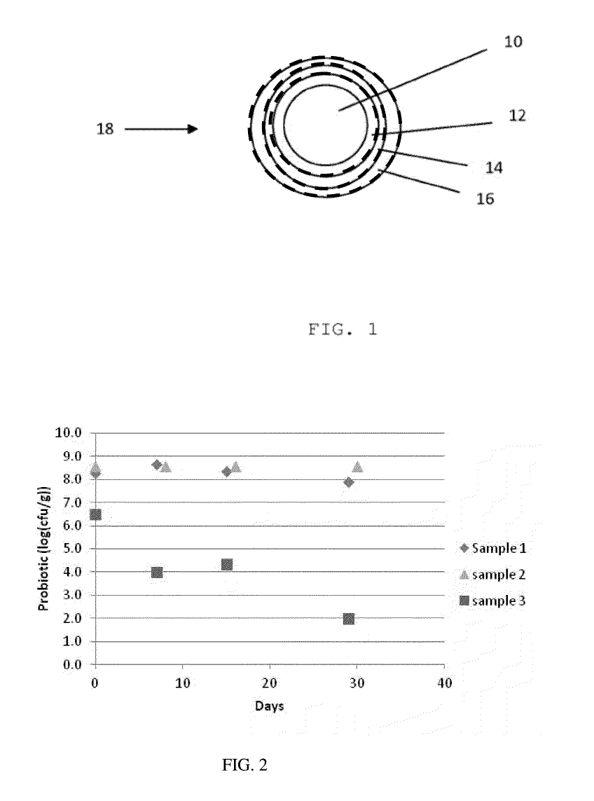

Sample 1 was a mixture of AHC-7 raw material (AHC-7 raw material comprised AHC-7 (probiotic) and maltodextrin (carrier) in an amount sufficient enough to achieve target AHC-7 concentration of around 10¹¹ cfu/g) and palatant 336 (ratio approximately 1:295). Sample 2 was a mixture of AHC-7 raw material and chicken fat containing antioxidant (ratio approximately 1:1086). Sample 3 was a mixture of AHC-7 raw material and glycerin (ratio approximately 1:2090). To avoid error due to mixing and improve accuracy of measurement, for each Sample (1, 2 and 3) four separate sample sets (four for Sample 1, four for Sample 2, and four for Sample 3), comprising 50 ml plastic tubes loaded with 10 g of Sample each, were prepared for four pull times. The Samples (1, 2 and 3) in a plastic tube were mixed thoroughly on a vortex type of mixer at room temperature and each tube was later sealed using a plastic cap. Samples 1, 2 and 3 (4 tubes for each of the samples) were stored at 23° C. (representative of typical room/store temperature) to assess stability of AHC-7 in the presence of other coating components. During stability assessment of AHC-7, 10 g of Sample that was placed in a plastic tube was used at the respective pull time. Samples were pulled from storage condition of 23° C. at time intervals of 0, 8, 16 and 30 days for Sample 1 and 0, 7, 15 and 29 days for Samples 2 and 3. AHC-7 probiotic loss in Samples 1, 2 and 3 at 23° C. is shown in FIG. 2. The AHC-7 loss is measured as delta between initial AHC-7 count (cfu/g) and AHC-7 count at respective pull (cfu/g). The AHC-7 count is expressed as log count. The results show that AHC-7 was very stable when in direct contact with palatant (Sample 1) and chicken fat (Sample 2). However, AHC-7 showed rapid loss when in direct contact with glycerin (Sample 3). The data demonstrates susceptibility of AHC-7 when in contact with glycerin and good stability when in presence of fat and dry palatant.

### Example 2

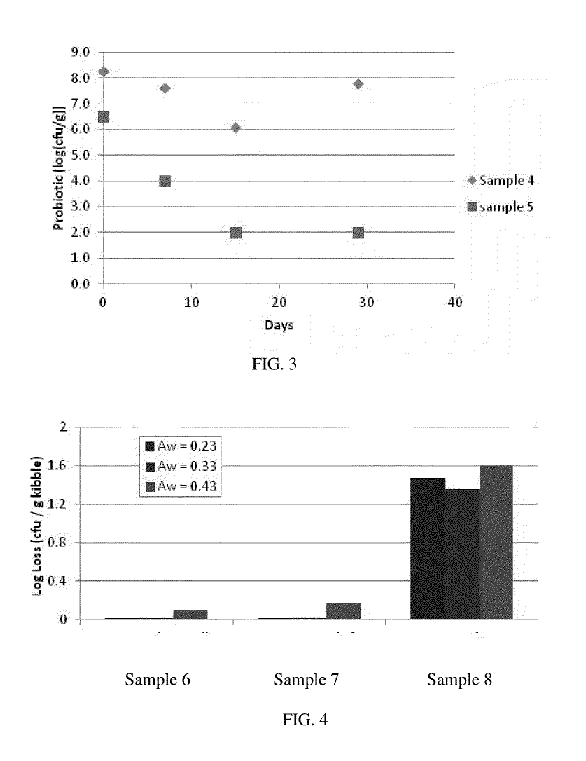

To determine stability of AHC-7 probiotic in the presence of other coating components at higher temperature (40° C.) another set of samples were made just like EXAMPLE 1. Sample 4 was a mixture of AHC-7 raw material (AHC-7 raw material is AHC-7 (probiotic) and maltodextrin (carrier)) added sufficient enough to achieve target AHC-7 concentration of around 10¹¹ cfu/g) and chicken fat containing antioxidant (ratio approximately 1:1086). Sample 5 was a mixture of AHC-7 raw material and glycerin (ratio approximately 1:2090). This example is without palatant To avoid error due to mixing and improve accuracy of measurement, for each Sample (4 and 5) four separate sample sets (four for Sample 4 and four for Sample 5), comprising 50 ml plastic tubes loaded with 10 g of Sample each, were prepared for four pull times. The Samples 4 and 5 in a plastic tube were mixed thoroughly on vortex type of mixer at room temperature and tube was later sealed using a plastic cap. Samples 4 and 5 (4 tubes for each of the sample) were stored at 40° C. to assess stability of AHC-7 in presence of other coating components. During stability assessment of AHC-7, 10 g of sample that was placed in a plastic tube was used at a respective pull time. Samples were pulled from storage condition of 40° C. at time interval of 0, 7, 15 and 29 days for Samples 4 and 5. AHC-7 probiotic loss in Samples 4 and 5 at 40° C. is shown in FIG. 3. AHC-7 was very stable when in direct contact with chicken fat (Sample 4) at higher temperature of 40° C. for 29 days. However, AHC-7 showed rapid loss when in direct contact with glycerin (Sample 5). The loss rate appeared to be greater at higher temperature (40° C.) (Sample 5) compared to 23° C. (Sample 3). The data demonstrates susceptibility of AHC-7 when in contact with glycerin and good stability when in the presence of fat.

### Example 3

To determine if coating has an effect on probiotic stability, various samples were prepared with different kibble coatings. First kibble was produced by extrusion of ingredients listed in TABLE 1 which delivered a kibble with a fat and protein content of 13% and 28% respectively. For kibble making, the dry ingredients (listed in TABLE 1) were blended in batches of 1000 kg for around 20 min using a Hobart® blender (model V-1401; Hobart, Troy, Ohio) to achieve reasonable homogeneity in the blend prior to processing. The blend of ingredients was transferred to a pre-conditioner cylinder, where the materials were mixed at 95° C. for 3 min with sufficient steam/water (approximately 21% water) to partially gelatinize starches and soften and hydrate all ingredients. The hydrated blend of ingredients was then extruded with a single screw extruder, with a barrel temperature ranging from 90° C. to 140° C. across the different extruder barrel zones (1-6). The diameter of the die used to make this product was 0.28″. Kibbles were dried to a final moisture content from 2.5% to 3.5%, and the water activity (Aw) was approximately 0.2. The bulk density of the kibbles prior to the application of the coatings was 360 g/lt. The components of the kibble are shown in TABLE 1

TABLE 1

| | | | | Finished | | | |
|---|---|---|---|---|---|---|---|
| | | Internal | | Product Total | | | |
| | Amount of | Glycerin | | Protein & Fat | | | Moisture |
| | Dry Ingredient | Sources (% | Bulk | Content Sources | | Aw (day 1 | Content |
| | (% by weight | by weight | Density | (% by weight | | of | (day1 of |
| Dry Ingredient | of kibble) | of kibble) | (g/L) | of kibble) | | incubation) | incubation) |
| Corn, Yellow | 31.267 | 0% | 360 | Protein: | 28% | 0.21 | 2.62% |
| Beet Pulp | 2.963 | | | Fat: | 13% | | |

| | |
|---|---|
| Salt | 0.494 |
| DL-Methionine | 0.126 |
| CBPM Refined | 2.322 |
| CBPM Prime | 28.976 |
| Rice, Brewers | 4.445 |
| Potassium Chloride | 0.373 |
| Choline Chloride | 0.127 |
| Flax, Ground | 0.178 |
| Barley Flour | 4.441 |
| Sorghum Grain | 23.756 |
| Mineral Premix Dog | 0.255 |
| Vit, Dog, Dry | 0.147 |
| Vitamin E BaseMix | 0.132 |

After drying, the kibbles were spray-coated with multiple coatings. Three separate sample groups of kibbles were coated, as shown in TABLE 2. Each sample group comprised of 30 grams of coated kibble.

TABLE 2

| Sample | | | |
|---|---|---|---|
| Group | 1^{st} Layer | 2^{nd} Layer | 3^{rd} Layer |
| 6 | Chicken Fat/Beef | AHC-7/SPF336 dry pal | n/a |
| | Tallow | mix | |
| 7 | Chicken Fat/Beef | AHC-7/SPF336 dry pal | n/a |
| | Tallow w/T-180 | mix | |
| | emulsifier | | |
| 8 | Glycerin | Chicken Fat/Beef Tallow | AHC-7/SPF336 |
| | | | dry pal mix |

For Sample Group 6: after drying, the kibbles were spray coated with a fat layer (not more than 6% by total weight of coated kibble) comprising a blend of 50% chicken fat, 50% beef tallow and having a melting temperature typically of 35° C. After the kibbles were coated with the fat layer, a dry blend layer was applied to the fat-coated surface of the kibble. This blend comprised about 1.2% of palatant (SPF 336) and about 0.02% of AHC-7 raw material (AHC-7 raw material comprised AHC-7 (probiotic) and maltodextrin (carrier) in an amount sufficient enough to achieve target AHC-7 concentration of around 10¹¹ cfu/g). This application resulted in probiotic material concentration of about 0.02% by weight of the coated kibble, giving an initial AHC-7 concentration of 10⁸ cfu/g. The second layer was added after the first fat layer. The second layer was applied after the first layer by using a single pass through mixer with multiple delivery ports. The temperature of the fat layers is about 10° C. higher than the melting point to ensure no problems during pumping and handling and to ensure maximum absorption into the kibble.

For Sample Group 7: after drying, the kibbles were spray coated with a fat layer comprising a blend of 49% chicken fat, 49% beef tallow, and 2% of a emulsifier (Trancendim® 180, Caravan Ingredients, Lenexa, Kans.) to obtain a fat layer concentration of about 5% by weight of the coated kibble. The emulsifier used has a melting temperature of between 56° C.-68° C. and comprises a ratio of monoglycerides to diglycerides of from about 5:1 to about 25:1 (average ratio approximately 12:1). After the kibbles were coated with the fat layer, a dry blend layer was applied to the fat-coated surface of the kibble. This blend comprised of about 1.2% of palatant (SPF 336) and about 0.02% of AHC-7 raw material (AHC-7 raw material is AHC-7 (probiotic) and maltodextrin (carrier)) added sufficient enough to achieve target AHC-7 concentration of around 10¹¹ cfu/g). This application resulted in AHC-7 raw material concentration of about 0.02% by weight of the coated kibble, giving an initial AHC-7 concentration of 10⁸ cfu/g. The second layer is added after the first fat layer. The second layer was applied after the first layer by using a single pass through mixer with multiple delivery ports. The temperature of the fat layers is about 10° C. higher than the melting point to ensure no problems during pumping and handling and to ensure maximum absorption into the kibble.

For Sample Group 8: after drying, the kibbles were spray-coated with a layer of glycerin (Chemical Division, P&G, Cincinnati, Ohio) at 35° C. to 50° C. to obtain a concentration of external glycerin of 2.5% by weight of the coated kibble. The glycerin used was 99.7% glycerin, MC=0.3%, specific gravity (at 25° C.)=1.261 g/min, percent glycerin on anhydrous bases=99-101. This coating of glycerin was absorbed immediately by the kibble. After the kibble was coated with glycerin, a layer of fat comprising a blend of 50% chicken fat and 50% beef tallow was applied to the glycerin-coated surface of the kibble. This application resulted in a fat layer concentration of about 5% by weight of the coated kibble. After the kibbles were coated with the fat layer, a dry blend layer was applied to the fat-coated surface of the kibble. This blend comprised of about 1.2% of palatant (SPF 336) and about 0.02% of AHC-7 raw material (AHC-7 raw material is AHC-7 (probiotic) and maltodextrin (carrier)) added sufficient enough to achieve target AHC-7 concentration of around 10¹¹ cfu/g). This application resulted in AHC-7 raw material concentration of about 0.02% by weight of the coated kibble, giving an initial AHC-7 concentration of 10⁸ cfu/g. The second layer is added after the first fat layer. The second layer was applied after the first layer by using a single pass through mixer with multiple delivery ports. The temperature of the fat layers is about 10° C. higher than the melting point to ensure no problems during pumping and handling and to ensure maximum absorption into the kibble.

The finished kibbles for Sample Groups 6, 7 and 8 were placed in open petri dishes and incubated in 25° C. desiccators of different relative humidities (RHs) for 1 month. The RHs of the desiccators were maintained using saturated salt slurries of water activities (Aw) 0.23, 0.33, and 0.43 (i.e., desiccator RH=salt slurry Aw×100%). By the end of the incubation period, there were no changes observed in the water activity of Sample Groups 6, 7 or 8 versus time. This stability in Aw showed that the kibbles had reached equilibrium moisture contents (M.C.'s), and thus equilibrium Aw's, which were also equivalent to the Aw's of the salt slurries in the desiccators, as shown in TABLE 3. This ensures that kibbles are at equilibrium which, is used to differentiate between samples with respect to water activity and moisture content.

TABLE 3

| | Moisture | Moisture | Moisture |
|---|---|---|---|
| Kibble | Content at | Content at | Content at |
| Product | Aw = 0.23 | Aw = 0.33 | Aw = 0.43 |
| CONTROL | 2.97% | 4.01% | 4.92% |

The affect of the various coatings used in Sample Groups 6, 7 and 8 on AHC-7 stability is plotted in FIG. 4. The Log Loss was calculated by taking the Log of AHC-7 level determined by Total Plate Count and checking the difference between T=0 and AHC-7 count at the end of 1 month when kibbles were equilibrated with respect to water activity. The data in FIG. 4 shows that the AHC-7 is highly stable with and without the presence of the Trancendim® 180 emulsifier in the fat (Sample Groups 6 & 7). However, the external layer of glycerin proved to be detrimental to AHC-7 stability, as shown by the decreased amount of AHC-7 probiotic levels in Sample Group 8.

A similar effect was observed, to that of Sample Group 3 and 5, when the AHC-7 probiotic was incubated with the raw material (glycerin) alone (EXAMPLE 1 and 2). After 1 month, there was >4.64 log loss of colony-forming units per gram of kibble; whereas, the AHC-7 probiotic was very stable when incubated with the SPF 336 dry palatant, as shown in Sample Groups 6 and 7.

The data in FIG. 4 also shows that the AHC-7 probiotic may be detected after a 1-month incubation period at Aw's as high as 0.43. However, this does not suggest that the AHC-7 probiotic is stable at such high Aw's for a prolonged period of time. It is possible that the AHC-7 probiotic may rapidly die with time under these conditions.

### Example 4

To determine if glycerin incorporated into a kibble had a detrimental effect on the stability of coated AHC-7 the following samples were prepared, the components of which are listed in TABLE 4. First kibble was produced by extrusion of ingredients listed in TABLE 1 which delivered a kibble with a fat and protein content of 13% and 28% respectively. For kibble making, the dry ingredients (listed in TABLE 4) were blended in batches of 1000 kg for around 20 min using a Hobart® blender (model V-1401; Hobart, Troy, Ohio) to achieve reasonable homogeneity in the blend prior to processing. In Sample Groups 11 and 12, glycerin was used as a plasticizer and was pumped directly into the pre-conditioner cylinder, where it is incorporated into the dough. The level of glycerin added internally to the kibble was 9%. In the pre-conditioner cylinder, the materials were mixed at 95° C. for 3 min with sufficient steam/water (approximately 21% water) to partially gelatinize starches and soften and hydrate all ingredients. The hydrated blend of ingredients was then extruded with a single screw extruder, with a barrel temperature ranging from 90° C. to 140° C. across the different extruder barrel zones (1-6). The diameter of the die used to make the kibbles was 0.28″.

TABLE 4

| | | Amount of | | | Kibble Total | | | | Moisture |
|---|---|---|---|---|---|---|---|---|---|
| | | Dry Ingredient | Internal | Bulk | Protein & | | | Aw (day 1 | Content |
| Sample | Dry | (% by weight | Glycerin | Density | Fat Content | | Internal | of | (day1 of |
| Group # | Ingredient | of kibble) | (% of kibble) | (g/L) | (% of kibble) | | Specks | incubation) | incubation) |
| CONTROL | Corn, Yellow | 31.267 | 0% | 360 | Protein: | 28% | no | 0.21 | 2.62% |
| Sample | Beet Pulp | 2.963 | | | Fat: | 13% | | | |
| Group 9 | Salt | 0.494 | | | | | | | |
| | DL- | 0.126 | | | | | | | |
| | Methionine | | | | | | | | |
| | CBPM | 2.322 | | | | | | | |
| | Refined | | | | | | | | |
| | CBPM Prime | 28.976 | | | | | | | |
| | Rice, Brewers | 4.445 | | | | | | | |
| | Potassium | 0.373 | | | | | | | |
| | Chloride | | | | | | | | |
| | Choline | 0.127 | | | | | | | |
| | Chloride | | | | | | | | |
| | Flax, Ground | 0.178 | | | | | | | |
| | Barley Flour | 4.441 | | | | | | | |
| | Sorghum | 23.756 | | | | | | | |
| | Grain | | | | | | | | |
| | Mineral | 0.255 | | | | | | | |
| | Premix Dog | | | | | | | | |
| | Vit, Dog, Dry | 0.147 | | | | | | | |
| | Vitamin E | 0.132 | | | | | | | |
| | BaseMix | | | | | | | | |
| Sample | Beet Pulp | 2.985 | 0% | 349 | Protein: | 28% | no | 0.20 | 2.09% |
| Group 10 | Egg Product | 4.949 | | | Fat: | 13% | | | |
| | Salt | 0.4974 | | | | | | | |
| | DL- | 0.1 | | | | | | | |
| | Methionine | | | | | | | | |
| | Potato Flour | 4.974 | | | | | | | |
| | Fish Meal | 7.959 | | | | | | | |
| | Rice, Brewers | 23.871 | | | | | | | |
| | Dicalcium | 1.142 | | | | | | | |
| | Phosphate | | | | | | | | |
| | Potassium | 0.6742 | | | | | | | |
| | Chloride | | | | | | | | |
| | Choline | 0.1396 | | | | | | | |
| | Chloride | | | | | | | | |
| | Flax, Ground | 0.1492 | | | | | | | |
| | Chicken66 | 4.267 | | | | | | | |
| | Barley Flour | 9.949 | | | | | | | |
| | Mineral | 0.2769 | | | | | | | |
| | Premix Dog | | | | | | | | |
| | Chicken | 2.23 | | | | | | | |
| | Meal183 | | | | | | | | |
| | Oat Flour | 23.866 | | | | | | | |
| | Vit, Dog, Dry | 0.153 | | | | | | | |
| | Vitamin E | 0.1355 | | | | | | | |
| | BaseMix | | | | | | | | |
| | Chicken | 11.682 | | | | | | | |
| | Meal42 | | | | | | | | |
| Sample | Same as | Same as | 9% | 363 | Protein: | 28% | no | 0.24 | 2.34% |
| Group 11 | Sample | Sample | | | Fat: | 13% | | | |
| | Group 10 | Group 10 | | | | | | | |
| Sample | Same as | Same as | 9% | 374 | Protein: | 28% | 10% Carrots, | 0.23 | 2.31% |
| Group 12 | Sample | Sample | | | Fat: | 13% | 4% Peas, | | |
| | Group 10 | Group 10 | | | | | 3% HPMC | | |
| | | | | | | | Glitter | | |
| | | | | | | | Flakes | | |

After drying, the kibbles were spray-coated with multiple coatings. The four Sample Groups of kibbles (Sample Groups 9 to 12) were coated similarly to Sample Group 6 in TABLE 2. Each Sample Group comprised 30 grams of kibble (at average density of 300 to 375 g/L)

For Sample Groups 9 to 12: after drying, the kibbles were spray coated with a fat layer no more than 6% by weight of the coated kibble, comprising a blend of 50% chicken fat, 50% beef tallow and having a melting temperature typically of 35° C. After the kibbles were coated with the fat layer, a dry palatant layer was applied to the fat-coated surface of the kibble. This blend comprised about 1.2% of palatant (SPF 336) and about 0.02% of AHC-7 raw material (AHC-7 raw material is AHC-7 (probiotic) and maltodextrin (carrier)) added sufficient enough to achieve target AHC-7 concentration of around 10¹¹ cfu/g). This application resulted in probiotic raw material concentration of about 0.02% by weight of the coated kibble, giving an initial AHC-7 concentration of 10⁸ cfu/g. The second layer is added after the first fat layer. The second layer is applied after the first one by using a single pass through mixer with multiple delivery ports. The temperature of the fat layers is about 10° C. higher than the melting point to ensure no problems during pumping and handling and to ensure maximum absorption into the kibble.

The finished kibbles for sample groups 9 to 12 were placed in open petri dishes and incubated in 25° C. desiccators of different relative humidities (RHs) for 1 month. The RHs of the desiccators were maintained using saturated salt slurries of water activities (Aw) 0.23, 0.33, and 0.43 (i.e., desiccator RH=salt slurry Aw×100%).

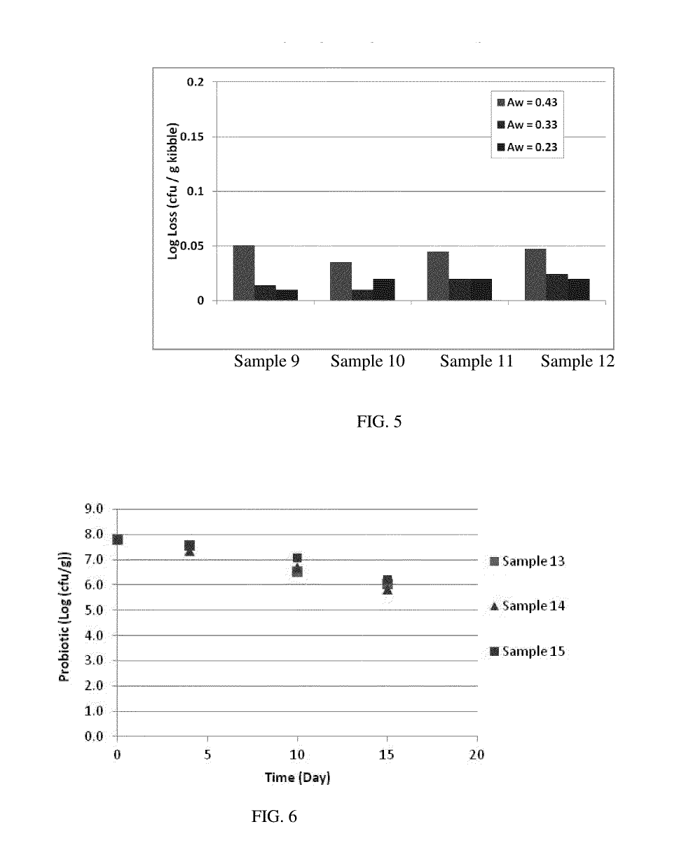

As shown in FIG. 5, after the 1-month incubation period, there was observed a less than about 0.1 log loss of the AHC-7 probiotic on the kibble products at the different RHs. The graph shows that at the end of storage there was no loss at either of the Aws. The data shows that, at time “0”, AHC-7 is highly stable on the surface of the sample groups lacking glycerin (Sample Groups 9 and 10) and the Sample Groups having 9% internal glycerin (Sample Groups 11 and 12); and Aw levels (0.23-0.43). This data contrasts with the high log loss of AHC-7 observed in Sample Group 8 (see FIG. 4), which has an external layer of glycerin. Therefore, this work shows that internal glycerin has little to no negative effect on the stability of AHC-7 coated bacteria, as contrasted with the external glycerin coating, even when the AHC-7 is separated from the glycerin coat by a layer of coated fat, as in Sample Group 8.

TABLE 5

| Sample | Moisture Content | Moisture Content | Moisture |
|---|---|---|---|
| Group | at Aw = 0.23 | at Aw = 0.33 | Content at Aw = 0.43 |
| 9 | 2.97% | 4.01% | 4.92% |
| 10 | 2.44% | 3.22% | 4.19% |
| 11 | 2.59% | 3.51% | 5.03% |
| 12 | 2.61% | 3.54% | 5.12% |

Furthermore, the observed log losses were similar for all the kibbles with the same Aw (see FIG. 5), which confirms the presence of glycerin internally has little to no impact on AHC-7 loss, in contrast to what was seen when glycerin was present externally; regardless of the kibble final moisture content (TABLE 5). These results confirm that the water activity of the kibble, not the moisture content, is a major factor affecting the probiotic stability at time “0”. This observation makes sense since water activity, not moisture content, determines the lower limit of available water for microbial growth. In addition, the data shows that the AHC-7 probiotic may be detected after a 1-month incubation period at Aw's as high as 0.43. However, this does not suggest that the probiotic is stable at such high Aw's for a prolonged period of time. It is possible that the probiotic may rapidly die with time under these conditions.

### Example 5

Impact of kibble incorporated glycerin on AHC-7 stability was tested. The components of the kibble samples are shown in TABLE 6.

TABLE 6

| Sample | Internal | | Amount of Dry Ingredient |
|---|---|---|---|
| No. | glycerin | Dry Ingredient | (% by weight of kibble) |
| 13 | No | Dog Vitamin | 0.153 |
| | | Dog Mineral | 0.277 |
| | | Vitamin-E | 0.136 |
| | | DL-Methionine | 0.100 |
| | | Choline Chloride | 0.139 |
| | | Dicalcium Phosphate | 1.147 |
| | | Potassium Chloride | 0.559 |
| | | Salt | 0.498 |
| | | Ground Flax Seed | 0.149 |
| | | Chicken Meal 66 | 4.308 |
| | | Chicken Meal 42 | 11.271 |
| | | Fish Meal | 7.959 |
| | | Whole Rice | 24.103 |
| | | Chicken Meal 183 | 2.245 |
| | | Whole Beet Pulp | 2.985 |
| | | Whole Barley | 9.949 |
| | | Egg | 4.949 |
| | | Oat Flour | 24.098 |
| | | Potato Flour | 4.975 |
| 14 | 3% | Dog Vitamin | 0.154 |
| | | Dog Mineral | 0.279 |
| | | Vitamin-E | 0.136 |
| | | DL-Methionine | 0.100 |
| | | Choline Chloride | 0.145 |
| | | Dicalcium Phosphate | 0.894 |
| | | Potassium Chloride | 0.438 |
| | | Salt | 0.499 |
| | | Ground Flax Seed | 0.150 |
| | | Chicken Meal 66 | 4.023 |
| | | Chicken Meal 42 | 12.785 |
| | | Fish Meal | 7.986 |
| | | Whole Rice | 22.508 |
| | | Chicken Meal 183 | 1.473 |
| | | Whole Beet Pulp | 2.995 |
| | | Whole Barley | 9.982 |
| | | Egg | 4.966 |
| | | Oat Flour | 22.503 |
| | | Potato Flour | 4.991 |
| 15 | 5% | Dog Vitamin | 0.154 |
| | | Dog Mineral | 0.279 |
| | | Vitamin-E | 0.136 |
| | | DL-Methionine | 0.100 |
| | | Choline Chloride | 0.150 |
| | | Dicalcium Phosphate | 0.964 |
| | | Potassium Chloride | 0.456 |
| | | Salt | 0.501 |
| | | Ground Flax Seed | 0.150 |
| | | Chicken Meal 66 | 3.790 |
| | | Chicken Meal 42 | 13.520 |
| | | Fish Meal | 8.007 |
| | | Whole Rice | 21.205 |
| | | Chicken Meal 183 | 1.387 |
| | | Whole Beet Pulp | 3.003 |
| | | Whole Barley | 10.009 |
| | | Egg | 4.979 |
| | | Oat Flour | 21.200 |
| | | Potato Flour | 5.005 |

Sample Groups 13, 14 and 15 were made on a small scale extruder. For kibble making, the dry ingredients (listed in Table 6) were blended in batches of 50 kg for around 10 min using a Hobart® blender (model HL-600; Hobart, Troy, Ohio) to achieve reasonable homogeneity in the blend prior to processing. The blend of ingredients was transferred to a pre-conditioner cylinder, where the materials were mixed at 95° C. for 3 min with sufficient steam/water (approximately 21% water) to partially gelatinize starches and soften and hydrate all ingredients. The hydrated blend of ingredients was then extruded with a twin screw extruder, with a barrel temperature ranging from 90° C. to 140° C. across the different extruder barrel zones (1-6). The diameter of the die used to make this product was 0.28″. Kibbles were dried to a final moisture content from 2.5% to 3.5%, and the water activity (Aw) was approximately 0.2. The bulk density of the kibbles prior to the application of the coatings was 350 g/lt. The components of the kibble are shown in TABLE 6. Sample Groups 13, 14 and 15 had similar dry kibble chassis except for the presence of glycerin at 3% and 5% internally in Sample Groups 14 and 15. The dry kibbles from the extruder (900 to 1200 g) were placed in a blender (Kitchen Aid, Heavy duty, Benton Harbor, Mich. USA), which was set on a slow setting (setting 2). Chicken fat was warmed up before being loaded on kibble and AHC-7 was mixed with it, while the chicken fat was mechanically stirred just before loading. The AHC-7 through fat (6% of coated kibble weight) was loaded on kibble (target AHC-7 count of 10⁷ cfu/g) through spray nozzle assembly equipped with peristaltic pump (Cole-Parmer, Chicago, USA), which allowed for a uniform spray of fat containing AHC-7 on the kibbles, which were slowly rotated in a blender (setting 2) to achieve uniform deposition of fat on the kibbles. Dry palatant plus sodium hexametaphosphate (1.6% of coated kibble weight) was added slowly on top of the kibbles sprayed with fat. Sample Groups 13, 14 and 15 were evaluated with respect to AHC-7 loss. The Sample Groups were transferred to paper bags and sealed using paper and plastic tape. The paper bags were stored in a constant condition chamber at 40° C. and 75% Relative humidity condition for 15 days. The Sample Groups were pulled at 0, 4, 10 and 15 days intervals and assessed for AHC-7 by plate count method. The results are shown in FIG. 6. The AHC-7 loss for Sample Groups without internal glycerin (Sample Group 13) and with internal glycerin at two different levels (Sample Groups 14 and 15) were not significantly different from each other (P>0.05). This confirms earlier results from EXAMPLE 4 that irrespective of kibble formulation (Example 4 had kibble formulation containing corn and chicken by product meal (CBPM), whereas example 5 had kibble formulation with no corn and no chicken by product meal), when glycerin is added internally there is little to no impact on AHC-7 loss.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A coated kibble comprising:
a kibble;
a coating on the kibble comprising a fat;
a coating on the kibble comprising a probiotic;
wherein the kibble comprises internal glycerin.

2. The coated kibble of claim 1, wherein the probiotic comprises Bifidobacterium animalis.

3. The coated kibble of claim 2, wherein the Bifidobacterium animalis has a 16s-23s intergenic polynucleotide sequence having at least 93% homology with the sequence according to SEQ ID NO. 1.

4. The coated kibble of claim 2, wherein following incubation at 25° C. for one month there is a less than about 0.1 log loss of Bifidobacterium animalis.

5. The coated kibble of claim 4, wherein the incubation is in a desiccator.

6. The coated kibble of claim 1, wherein the coated kibble comprises from about 1% to about 20% internal glycerin.

7. The coated kibble of claim 1, wherein the coated kibble comprises from about 10⁶ cfu/g to about 10⁸ cfu/g Bifidobacterium animalis.

8. The coated kibble of claim 1, wherein the water activity level was from about 0.1 to about 0.3.

9. The coated kibble of claim 1, wherein the fat is applied as a first coating and the probiotic as a second coating.

10. The coated kibble of claim 1, wherein the fat coating present in an amount from about 1% to about 15% by weight of the total coated kibble.

11. The coated kibble of claim 1, wherein the coated kibble has a “softness” value from about 1 kgf/cm² to about 9 kgf/cm².

12. The coated kibble of claim 1, wherein the coated kibble comprises a prebiotic.

13. The coated kibble of claim 1, wherein the coated kibble comprises a third coating.

14. The coated kibble of claim 13, wherein the third coating comprises a palatant.

15. The coated kibble of claim 14, wherein the palatant is a flavor component which could be dry or liquid.

16. A method for producing a coated kibble comprising:
a. extruding a kibble having internal glycerin; and
b. coating the kibble with Bifidobacterium animalis.

17. The method of claim 16, wherein the kibble is coated with fat.

18. The method of claim 17, wherein the fat is coated before the Bifidobacterium animalis is coated.

19. The method of claim 16, wherein the kibble is coated with from about 10⁶ cfu/g to about 10⁸ cfu/g of Bifidobacterium animalis.

20. The method of claim 16, wherein the coated kibble comprises from about 1% to about 20% internal glycerin.
